(19) United States
(12) Patent Application Publication
(10) Pub. No.: US 2003/0038814 A1
(43) Pub. Date: Feb. 27, 2003

(54) Virtual camera system for environment capture

(76) Inventor: Leo R. Blume, Palo Alto, CA (US)

Correspondence Address: BEVER HOFFMAN & HARMS, LLP, 2099 GATEWAY PLACE, SUITE 320, SAN JOSE, CA, 951101017

(21) Appl. No.: 09/940,871

(22) Filed: Aug. 27, 2001

(51) Int. Cl. G09G 5/00

(52) U.S. Cl. 345/585

(57) ABSTRACT

A virtual camera system includes a primary camera and one or more virtual cameras for generating panoramic environment data. Each virtual camera is emulated by a pair of secondary cameras that are aligned such that the nodal point of each camera lens form a line with the nodal point of the primary camera. The primary camera is aligned in a first direction to capture a first region of an environment surrounding the virtual camera system, and each pair of secondary cameras is aligned in parallel directions to capture secondary regions. Environment data captured by each pair of secondary cameras is combined to emulate a virtual camera having a nodal point coincident with that of the primary camera. Environment data captured by the primary camera and attributed to each virtual camera is then stitched together to provide a panoramic environment map from the single point of reference.

### CROSS-REFERENCE TO RELATED APPLICATIONS

This application relates to co-filed U.S. Application Serial No. XX/XXX,XXX, entitled “STACKED CAMERA SYSTEM FOR ENVIRONMENT CAPTURE” [ERT-011], which is owned by the assignee of this application and incorporated herein by reference.

### FIELD OF THE INVENTION

The present invention relates to environment mapping. More specifically, the present invention relates to multi-camera systems for capturing a surrounding environment to form an environment map that can be subsequently displayed using an environment display system.

### BACKGROUND OF THE INVENTION

Environment mapping is the process of recording (capturing) and displaying the environment (i.e., surroundings) of a theoretical viewer. Conventional environment mapping systems include an environment capture system (e.g., a camera system) that generates an environment map containing data necessary to recreate the environment of the theoretical viewer, and an environment display system that processes the environment map to display a selected portion of the recorded environment to a user of the environment mapping system. An environment display system is described in detail by Hashimoto et al., in co-pending U.S. patent application Ser. No. 09/505,337, entitled “POLYGONAL CURVATURE MAPPING TO INCREASE TEXTURE EFFICIENCY”, which is incorporated herein in its entirety. Typically, the environment capture system and the environment display system are located in different places and used at different times. Thus, the environment map must be transported to the environment display system typically using a computer network, or stored in on a computer readable medium, such as a CD-ROM or DVD.

FIG. 1(A) is a simplified graphical representation of a spherical environment map surrounding a theoretical viewer in a conventional environment mapping system. The theoretical viewer (not shown) is located at an origin 105 of a three-dimensional space having x, y, and z coordinates. The environment map is depicted as a sphere 110 that is centered at origin 105. In particular, the environment map is formed (modeled) on the inner surface of sphere 110 such that the theoretical viewer is able to view any portion of the environment map. For practical purposes, only a portion of the environment map, indicated as view window 130A and view window 130B, is typically displayed on a display unit (e.g., a computer monitor) for a user of the environment mapping system. Specifically, the user directs the environment display system to display window 130A, display window 130B, or any other portion of the environment map. Ideally, the user of the environment mapping system can view the environment map at any angle or elevation by specifying an associated display window.

FIG. 1(B) is a simplified graphical representation of a cylindrical environment map surrounding a theoretical viewer in a second conventional environment mapping system. A cylindrical environment map is used when the environment to be mapped is limited in one or more axial directions. For example, if the theoretical viewer is standing in a building, the environment map may omit certain details of the floor and ceiling. In this instance, the theoretical viewer (not shown) is located at center 145 of an environment map that is depicted as a cylinder 150 in FIG. 2. In particular, the environment map is formed (modeled) on the inner surface of cylinder 150 such that the theoretical viewer is able to view a selected region of the environment map. Again, for practical purposes, only a portion of the environment map, indicated as view window 160, is typically displayed on a display unit for a user of the environment mapping system.

Many conventional camera systems exist to capture the environment surrounding a theoretical viewer for each of the environment mapping systems described with reference to FIGS. 1(A) and 1(B). For example, cameras adapted to use a fisheye, or hemispherical, lens are used to capture a hemisphere of sphere 110, i.e., half of the environment of the theoretical viewer. By using two hemispherical lens cameras, the entire environment of viewer 105 can be captured. However, the images captured by a camera with a hemispherical lens require intensive processing to remove the distortions caused by the hemispherical lens in order to produce a clear environment map. Furthermore, two cameras provide very limited resolution for capturing the environment. Therefore, environment mapping using images captured with cameras having hemispherical lenses produce low-resolution displays that require intensive processing. Other environment capturing camera systems use multiple outward facing cameras. FIG. 2 depicts an outward facing camera system 200 having six cameras 211-216 facing outward from a center point C. Camera 211 is directed to capture data representing a region 221 of the environment surrounding camera system 200. Similarly, cameras 212-216 are directed to capture data representing regions 222-226, respectively. The data captured by cameras 211-216 is then combined in an environment display system (not shown) to create a corresponding environment map from the perspective of the theoretical viewer.

A major problem associated with camera system 200 is parallax, the effect produced when two cameras capture the same object from different positions. This occurs when an object is located in a region (referred to herein as an “overlap region”) that is located in two or more capture regions. For example, overlapping portions of capture region 221 and capture region 222 form overlap region 241. Any object (not shown) located in overlap region 241 is captured both by camera 211 and by camera 212. Similar overlap regions 242-246 are indicated for each adjacent pair of cameras 212-216. Because the position of each camera is different (i.e., adjacent cameras are separated by a distance D), the object is simultaneously captured from two different points. Accordingly, when the environment map data from both of these cameras is subsequently combined in an environment display system, a parallax problem is produced in which the single object may be distorted or displayed as two similar objects in the environment map, thereby degrading the image.

An extension to environment mapping is generating and displaying immersive videos. Immersive videos are formed by creating multiple environment maps, ideally at a rate of at least 30 frames a second, and subsequently displaying selected sections of the multiple environment maps to a user, also ideally at a rate of at least 30 frames a second. Immersive videos are used to provide a dynamic environment, rather than a single static environment as provided by a single environment map. Alternatively, immersive video techniques allow the location of the theoretical viewer to be moved relative to objects located in the environment. For example, an immersive video can be made to capture a flight in the Grand Canyon. The user of an immersive video display system would be able to take the flight and look out at the Grand Canyon at any angle. Camera systems for environment mappings can be easily converted for use with immersive videos by using video cameras in place of still image cameras.

Hence, there is a need for an efficient camera system for producing environment mapping data and immersive video data that minimizes the parallax associated with conventional systems.

### SUMMARY OF THE INVENTION

The present invention is directed to an environment capture system in which a primary (actual) camera and one or more virtual cameras are utilized to generate panoramic environment data that is, in effect, captured from a single point of reference, thereby minimizing the parallax. associated with conventional camera systems.

In a first embodiment, a camera system includes a primary camera located between a second camera and a third camera in a vertical stack. The lens of the primary camera defines the point of reference for the camera system, and an optical axis of the primary camera is aligned in a horizontal direction toward a primary region of the surrounding environment. The optical axes of the second and third cameras are parallel to each other and directed toward a secondary region of the surrounding environment. The second and third cameras emulate a virtual camera located at the point of reference and directed toward the secondary region by combining environment data captured by the second and third cameras using known techniques. The environment data captured by the primary camera and the combined environment data are then stitched together using known techniques, thereby producing panoramic environment data that appears to have been captured from the point of reference. Accordingly, a virtual camera system is provided for generating environment mapping data and immersive video data that minimizes the parallax associated with conventional camera systems.

In a second embodiment, a camera system includes the primary, second, and third cameras of the first camera systems, and also includes one or more additional pairs of cameras arranged to emulate one or more additional virtual cameras. The primary environment data and the combined environment data from each of the virtual cameras are then stitched together to generate a full (360 degree) panoramic environment map captured form a single point of reference.

The present invention will be more fully understood in view of the following description and drawings.

### BRIEF DESCRIPTION OF THE DRAWINGS

FIG. 1(A) is a three-dimensional representation of a spherical environment map surrounding a theoretical viewer;

FIG. 1(B) is a three-dimensional representation of a cylindrical environment map surrounding a theoretical viewer;

FIG. 2 is a simplified plan view showing a conventional outward-facing camera system;

FIG. 3 is a plan view showing a conventional camera system for emulating a virtual camera;

FIG. 4 is a front view showing a camera system according to a first embodiment of the present invention;

FIG. 5 is a partial plan view showing the camera system of FIG. 4;

FIG. 6 is a perspective view depicting the camera system of FIG. 4 including an emulated virtual camera;

FIG. 7 is a perspective view depicting a process of displaying an environment map generated by the camera system of the first embodiment;

FIG. 8 is a front view showing a stacked camera system according to a second embodiment of the present invention;

FIG. 9 is a plan view showing the stacked camera system of FIG. 8; and

FIG. 10 is a perspective view depicting a semi-cylindrical environment map generated using the stacked camera system shown in FIG. 8;

FIG. 11 is a perspective view depicting a camera system according to a third embodiment of the present invention; and

FIG. 12 is a partial plan view showing the camera system of FIG. 11.

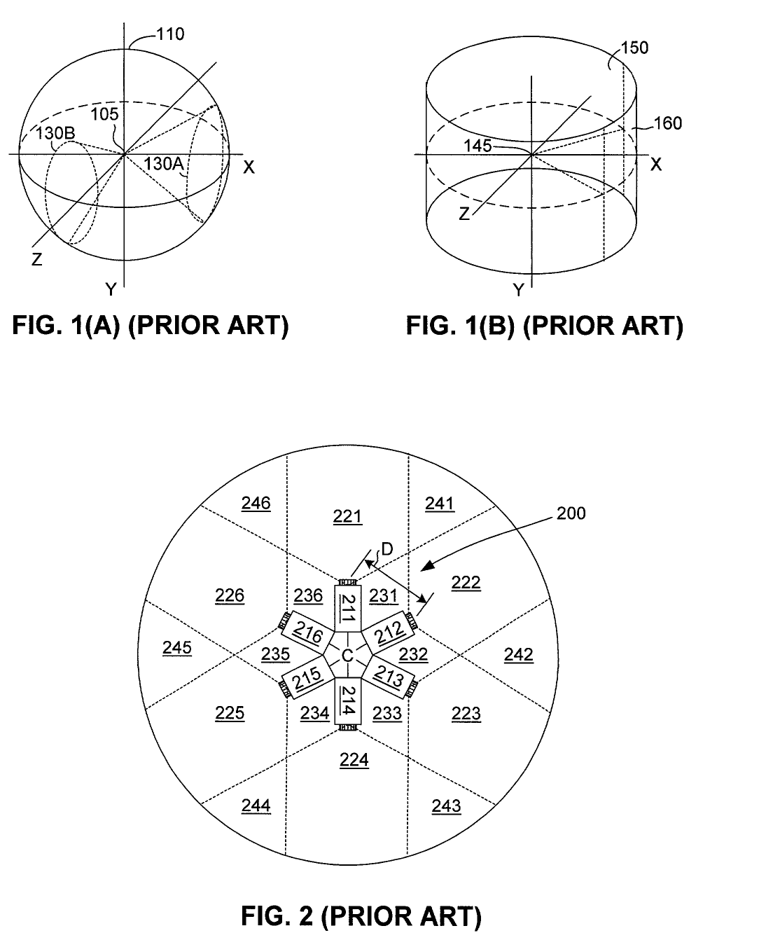

### DETAILED DESCRIPTION

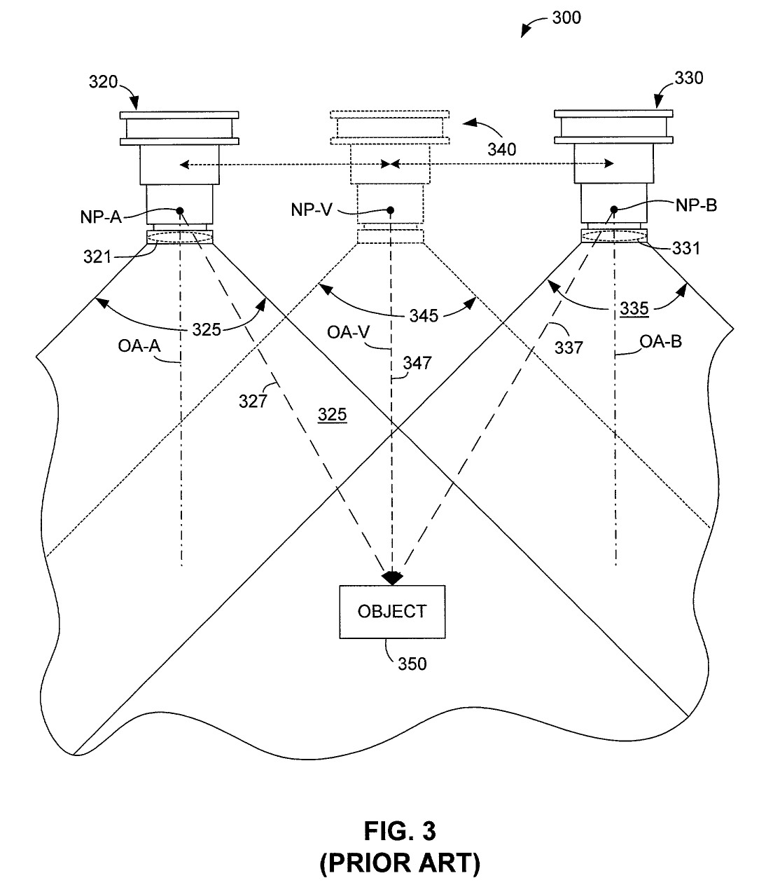

The present invention is directed to an environment capture system in which one or more virtual cameras are utilized to generate panoramic environment data. The term “virtual camera” is used to describe an imaginary camera that is emulated by combining environment data captured by two or more actual cameras. The process of emulating a virtual camera also known as “view morphing” is taught, for example, by Seitz and Dyer in Seitz et al., “View Morphing”, Computer Graphics Proceedings, Annual Conference Series, 1996, which is incorporated herein in its entirety, and is also briefly described below with reference to FIG. 3.

FIG. 3 is a plan view showing a camera system 300 including a first camera 320 and a second camera 330. Camera 320 has a lens 321 defining a nodal point NP-A and an optical axis OA-A. Camera 330 has a lens 331 defining a nodal point NP-B and an optical axis OA-B that is parallel to optical axis OP-A. Extending below camera 320 are diagonal lines depicting a capture region 325, and extending below camera 330 are diagonal lines depicting a capture region 335. In operation, environment data (objects) located in region 325 is captured (i.e., recorded) by first camera 320 from a point of reference defined by nodal point NP-A. Similarly, environment data located in region 335 is captured by second camera 330 from a point of reference defined by nodal point NP-B.

A virtual camera 340 is depicted in dashed lines between cameras 320 and 330. Virtual camera 340 is emulated by combining the environment data captured by first camera 320 and second camera 330 using various well known techniques, such as view morphing. The resulting combined environment data has a point of reference that is located between cameras 320 and 330. In other words, the combined environment data is substantially the same as environment data captured by a hypothetical single camera (i.e., the virtual camera) having a nodal point NP-V and optical axis OA-V. Accordingly, an object 350 located in capture regions 325 and 335 appears in environment data captured by camera 320 as being located along line-of-sight 327 (i.e., object 350 appears to the right of optical axis OA-A in FIG. 3), and appears in environment data captured by camera 330 as being located along line-of-sight 337 (i.e., object 350 appears to the left of optical axis OA-B in FIG. 3). When the environment data captured by cameras 320 and 330 is combined in accordance with the above-mentioned techniques, object 350 appears in combined environment data as being located along line-of-sight 347 (i.e., object 350 appears directly on virtual optical axis OA-V). Accordingly, the combined environment data emulates virtual camera 340 having a virtual nodal point NP-V that is located midway between first camera 320 and second camera 330. However, objects in very near virtual camera 340 which are not captured by either camera 320 or camera 340 would not appear in the combined environment data.

Three-Camera Embodiment

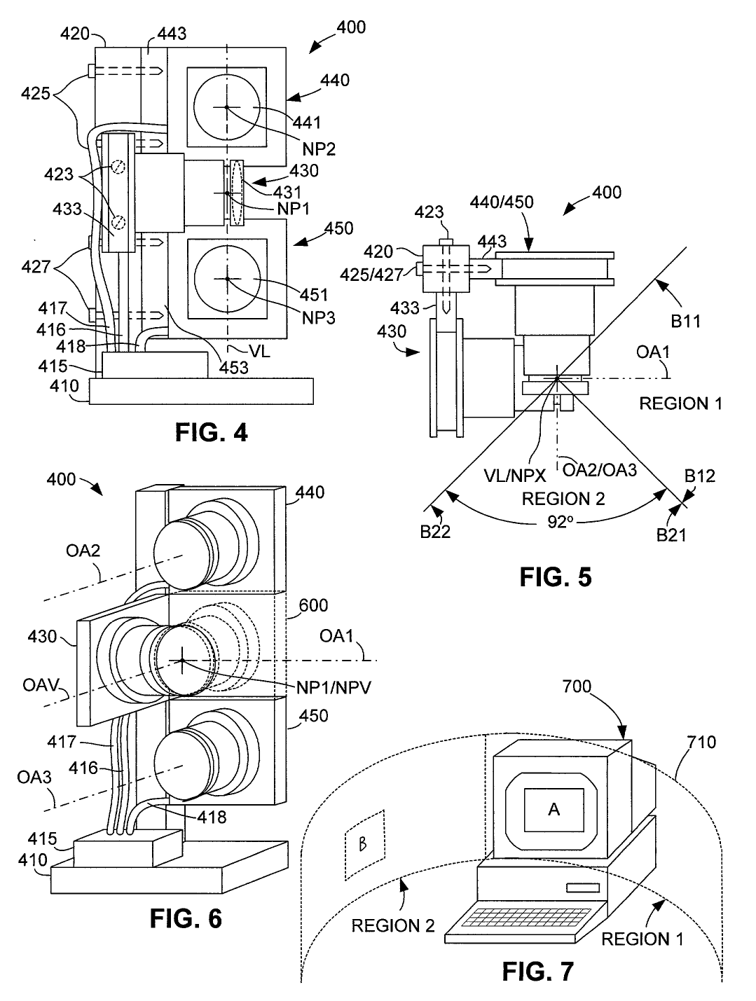

FIGS. 4, 5, and 6 are front, partial plan, and perspective views, respectively, showing a simplified camera system 400 in accordance with a first embodiment of the present invention. Camera system 400 includes a base 410 having a data interface 415 mounted thereon, a vertical beam 420 extending upward from base 410, and three video cameras fastened to vertical beam 420: a primary camera 430, a second camera 440 located over primary camera 430, and a third camera 450 located below primary camera 430.

Each camera 430, 440, and 450 is a video camera (e.g., model WDCC-5200 cameras produced by Weldex Corp. of Cerritos, Calif.) that performs the function of capturing a designated region of the environment surrounding camera system 400. Environment data captured by each camera is transmitted via cables to data interface 415 and then to a data storage device (not shown) in a known manner. For example, environment data captured by primary camera 430 is transmitted via a cable 416 to data interface 415. Similarly, environment data captured by second camera 440 and environment data captured by third camera 450 is transmitted via cables 417 and 418, respectively, to data interface 415. Some embodiments of the present invention may couple cameras 430, 440, and 450 directly to a data storage device without using data interface 415. As described below, the environment data stored in the data storage device is then manipulated to produce an environment map that can be displayed singularly, or used to form immersive video presentations.

Each camera 430, 440, and 450 includes a lens defining a nodal point and an optical axis. For example, primary camera 430 includes a lens 431 that defines a nodal point NP1 (shown in FIG. 4), and defines an optical axis OA1 (shown in FIG. 5). Similarly, second camera 440 includes lens 441 that defines nodal point NP2 and optical axis OA2, and third camera 450 includes lens 451 that defines nodal point NP3 and optical axis OA3. In one embodiment, primary camera 430, second camera 440, and third camera 450 are stacked such that nodal points NP1, NP2, and NP3 are aligned along a vertical line VL (shown in FIGS. 4 and 5), thereby allowing cameras 430, 440, and 450 to generate environment data that is used to form a portion of a cylindrical environment map, such as that shown in FIG. 7 (described below). In particular, as shown in FIG. 5, optical axis OA1 of camera 430 is directed into a first capture region designated as REGION1. Similarly, optical axes OA2 and OA3 of second camera 440 and third camera 450, respectively, are directed into a second capture REGION2. Capture regions REGION1 and REGION2 are depicted in FIG. 5 as being defined by a corresponding pair of radial horizontal boundaries that extend from the nodal point of each camera. For example, capture region REGION1 is defined by radial boundaries B11 and B12. Similarly, capture region REGION2 is defined by radial boundaries B21 and B22 (the vertical offset between the capture regions of second camera 440 and third camera 450 is ignored for reasons that will become apparent below). In one embodiment, each pair of radial boundaries (e.g., radial boundaries B21 and B22) define an angle of 92 degrees, and each radial boundary slightly overlaps a radial boundary of an adjacent capture region (e.g., radial boundary B21 slightly overlaps radial boundary B22).

In accordance with an aspect of the present invention, optical axis OA1 of primary camera 430 that extends in a first horizontal direction (e.g., to the right in FIG. 5), and optical axes OA2 and OA3 of second camera 440 and third camera 450, respectively, are parallel and extend in a second horizontal direction (e.g., downward in FIG. 5). In the disclosed embodiment, the first horizontal direction is perpendicular to the second horizontal direction, although in other embodiments other angles may be used.

In accordance with another aspect of the present invention, an environment map is generated by combining environment data captured by second camera 440 and third camera 450 to emulate virtual camera 600 (depicted in FIG. 6 in dashed lines), and then stitching the combined environment data with environment data captured by primary camera 430. In particular, first environment data is captured by primary camera 430 from first capture region REGION1. Simultaneously, second environment data is captured by second camera 440 and third environment data is captured by third camera from second capture region REGION2. Next, the second environment data and the third environment data captured by second camera 440 and third camera 450, respectively, is combined in accordance with the techniques taught, for example, in “View Morphing”, thereby emulating an imaginary camera 600 (i.e., producing combined environment data having the same point of reference as that of primary camera 430). This combining process is implemented, for example, in a computer system (not shown), an embedded processor (not shown), or in a separate environment display system. Finally, the combined environment data associated with emulated virtual camera 600 is stitched with the first environment data captured by primary camera 430 to generate an environment map depicting capture regions REGION1 and REGION2 that essentially eliminates the seams caused by parallax. The environment map thus generated is then displayable on an environment display system, such as that disclosed in co-owned and co-pending U.S. patent application Ser. No. 09/505,337 (cited above).

Referring again to FIG. 4, in the disclosed embodiment, cameras 430, 440, and 450 are rigidly held by a support structure including base 410 and vertically arranged rigid beam 420. Each camera includes a mounting board that is fastened to beam 420 by a pair of fasteners (e.g., a screws). For example, primary camera 430 includes a mounting board 433 that is connected by fasteners 423 to a first edge of beam 420. Second camera 440 includes a mounting board 443 that is connected by fasteners 425 to a second edge of beam 420. Similarly, third camera 450 includes a mounting board 453 that is connected by fasteners 427 to the second edge of beam 420. Note that base 410, data storage device 415, and beam 420 are simplified for descriptive purposes to illustrate the fixed relationship between the three cameras, and may be replaced with any suitable support structure. Note that primary camera 430, second camera 440, and third camera 450 should be constructed and/or positioned such that, for example, the body of primary camera 430 does not protrude significantly into the capture regions recorded by second camera.

FIG. 7 is a simplified diagram illustrating a computer (environment display system) 700 for displaying an environment map 710. Computer 700 is configured to implement an environment display system, such as that disclosed in co-owned and co-pending U.S. patent application Ser. No. 09/505,337 (cited above). In accordance with another aspect of the present invention, the combined environment data associated with virtual camera 600 (see, e.g., FIG. 6) is stitched together with the environment data captured by primary camera 430 (FIG. 6) to produce environment map 710, which is depicted as a semi-cylinder. As indicated in FIG. 7, only a portion of environment map 710 (e.g., an object “A” located in capture region REGION1) is displayed on the monitor of computer 700 at a given time. To view other portions of environment map 710 (e.g., an object B located in capture region REGION2), a user inputs appropriate command signals into computer 700 such that the implemented environment display system “rotates” environment map 710 to display the desired environment map portion.

In accordance with another aspect of the present invention, environment map 710 minimizes parallax because, by emulating virtual camera 600 such that virtual nodal point NPV coincides with nodal points NP1 of primary camera 430, environment map 710 is generated from a single point of reference (i.e., located at nodal point NP1/NPV; see FIG. 6). In particular, as indicated in FIG. 5, by emulating virtual camera 600 according to the present invention, capture regions REGION1 and REGION2 originate from a common nodal point NPX, Even though there is a slight capture region overlap located along the radial boundaries (described above), parallax is essentially eliminated because each associated camera perceives an object in this overlap region from the same point of reference.

Note that the environment data captured by primary camera 430, second camera 440, and third camera 450 may be combined using a processor coupled to the data storage, a separate processing system or in environment display system 700. Further, the environment data captured by primary camera 430, second camera 440, and third camera 450 may be still (single frame) data, or multiple frame data produced in accordance with known immersive video techniques.

Seven-Camera Embodiment

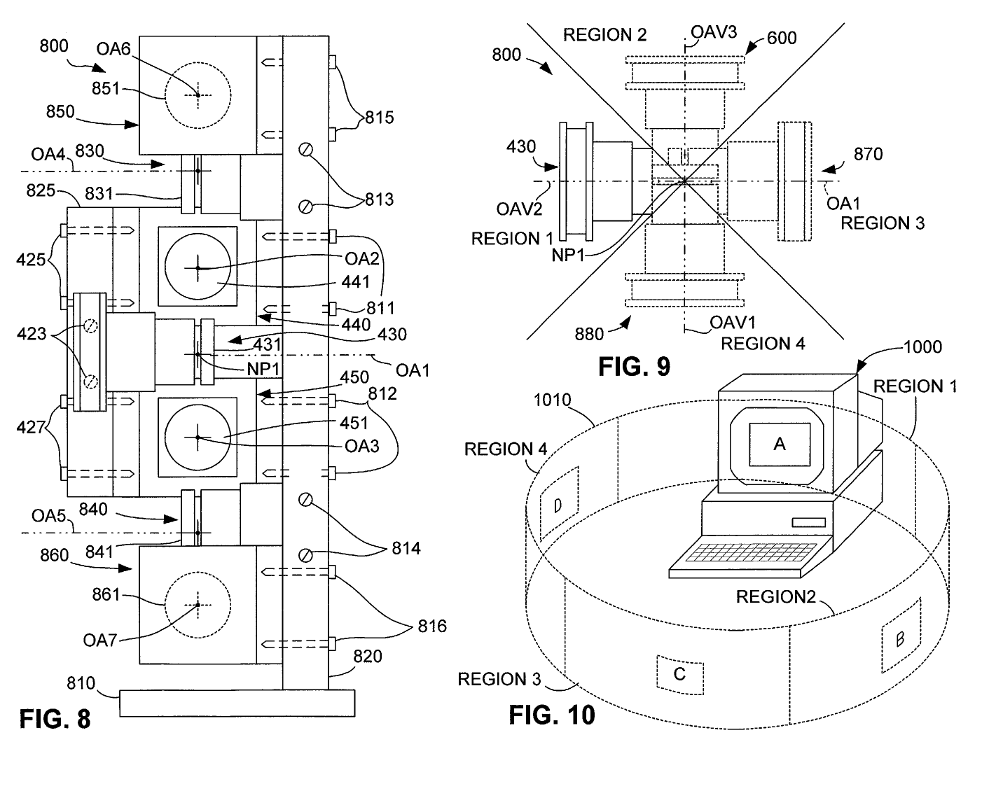

FIGS. 8 and 9 are front and partial plan views, respectively, showing a stacked camera system 800 for generating a full (i.e., 360 degree) panoramic environment map in accordance with a second embodiment of the present invention.

Camera system 800 includes primary camera 430, second camera 440, and third camera 450 that are utilized in camera system 400 (described above). In addition, camera system 800 includes a fourth camera 830 located over primary camera 430 and having a lens 831 defining an optical axis OA4 extending in a third horizontal direction (i.e., perpendicular to optical axes OA1 and OA2/OA3), and a fifth camera 840 located under primary camera 430 and having a lens 841 defining an optical axis OA5 extending in the third horizontal direction such that optical axes OA4 and OA5 are parallel. Moreover, camera system 800 includes a sixth camera 850 located over primary camera 430 and having a lens 851 defining an optical axis OA6 extending in a third horizontal direction (i.e., into the page and perpendicular to optical axes OA1, OA2/OA3, and OA4/OA5), and a seventh camera 860 located under primary camera 430 and having a lens 861 defining an optical axis OA7 extending in the third horizontal direction such that optical axes OA6 and OA7 are parallel. Similar to camera system 400 (discussed above), environment data captured by each camera is transmitted via cables to data storage device (not shown) in a known manner.

FIG. 9 is a partial plan view showing primary camera 430, virtual camera 600 (discussed above with reference to camera system 400), and two additional virtual cameras emulated in accordance with the second embodiment to capture the full (i.e., 360 degree) environment surrounding camera system 800. Specifically, primary camera 430 generates environment data from first capture region REGION1 from a point of reference determined by nodal point NP1. In addition, as described above, environment data captured by second camera 440 and third camera 450 is combined to emulate virtual camera 600, thereby generating environment data from second capture region REGION2 that is taken from a point of reference coincident with nodal point NP1 (which is defined by the lens of primary camera 430). Using the same technique, environment data captured by fourth camera 830 and fifth camera 840 is combined to emulate a third virtual camera 870, thereby generating environment data from a third capture region REGION3 that is also taken from a point of reference coincident with nodal point NP1. Finally, environment data captured by sixth camera 850 and seventh camera 860 is combined to emulate a fourth virtual camera 880, thereby generating environment data from a fourth capture region REGION4 that is also taken from a point of reference coincident with nodal point NP1. Accordingly, environment data is captured for the full panoramic environment surrounding camera system 800 that is captured from a single point of reference, thereby minimizing parallax.

FIG. 10 is a simplified diagram illustrating a computer 1000 (environment display system) for displaying a cylindrical environment map 1010 generated by stitching together the environment data generated as described above. Computer 1000 is configured to implement an environment display system, such as that disclosed in co-pending U.S. patent application Ser. No. 09/505,337 (cited above). As indicated in FIG. 10, only a portion of environment map 1010 (e.g., object “A” from capture region REGION1 is displayed at a given time. To view other portions of environment map 1010, a user manipulates computer 1000 such that the implemented environment display system “rotates” environment map 1010 to, for example, display an object “B” from capture region REGION2.

Returning to FIG. 8, camera system 800 is rigidly held by a support structure including base 810, a first beam 820 extending upward from base structure 810, and a second beam 825. First beam 820 is connected to a first edge of second camera 440 by fasteners 811, and to a first edge of third camera 450 by fasteners 812. Similarly, first beam 820 is connected to fourth camera 830 by fasteners 813, to fifth camera 840 by fasteners 814, to sixth camera 850 by fasteners 815, and to seventh camera 860 by fasteners 816. Similar to beam 420 (see FIG. 4), second beam 825 is connected to primary camera 430 by fasteners 423, to a second edge of second camera 440 by fasteners 425, and to a second edge of third camera 450 by fasteners 427. Note that second beam 825 is supported by second camera 440 and third camera 450, but in an alternative embodiment (not shown) may extend down to base 810.

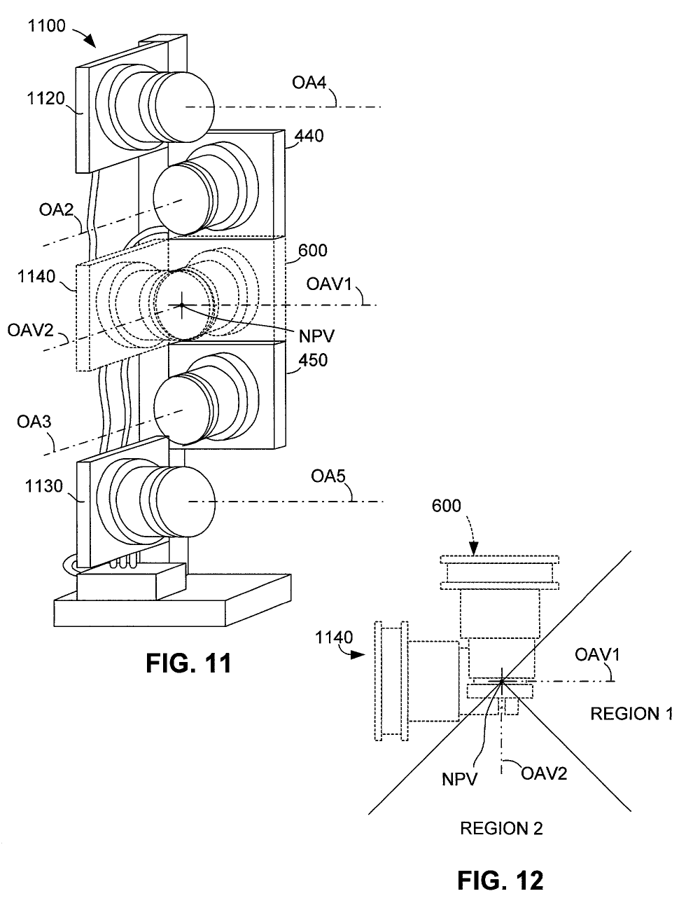

Although the present invention has been described with respect to certain specific embodiments, it will be clear to those skilled in the art that the inventive features of the present invention are applicable to other embodiments as well. For example, FIGS. 11 and 12 show a camera system 1100 according to a third embodiment of the present invention in which the primary camera of the first embodiment is replaced by a virtual camera. Specifically, camera system includes second camera 430 and third camera 440 of camera system 400, which emulate virtual camera 600 in the manner described above. In addition, instead of mounting primary camera 430 (see FIG. 4) between second camera 440 and third camera 450, a fourth camera 1120 is mounted above second camera 440, and a fifth camera 1130 is mounted below third camera 450. In the manner described above, environment data captured by fourth camera 1120 and fifth camera 1130 is combined to emulate a second virtual camera 1140, thereby generating environment data from first capture region REGION1 that is taken along a virtual optical axis OAV1 from a point of reference coincident with nodal NPV (which is also the point of reference of virtual camera 600, which defines a virtual optical axis OAV2). Accordingly, environment data for capture regions REGION1 and REGION2 without the use of a primary camera that can be stitched together to provide a semi-cylindrical environment map similar to that shown in FIG. 7. While camera system 1100 may provide beneficial advantages in certain applications, it is recognized that the use of an additional camera increases the cost of camera system 1100 over that of camera system 400 (discussed above). Therefore, the spirit and scope of the appended claims should not be limited to the description of the preferred embodiments contained herein.

1. A camera system for environment capture comprising:
a primary camera having a first lens defining a first optical axis extending in a first direction;
a second camera located on a first side of the primary camera and having a second lens defining a second optical axis extending in a second direction; and
a third camera located on a second side of the primary camera and having at third lens defining a third optical axis extending in the second direction such that the third optical axis is parallel to the second optical axis.

2. The camera system according to claim 1, further comprising means for emulating a first virtual camera by combining environment data captured by the second camera with environment data captured by the third camera.

3. The camera system according to claim 2, further comprising means for generating an environment map by stitching together the combined environment data with primary environment data captured by the primary camera.

4. The camera system according to claim 1,
wherein the first lens defines a first nodal point,
wherein the second lens defines a second nodal point,
wherein the third lens defines a third nodal point, and
wherein the primary camera, second camera, and third camera are stacked such that the first, second, and third nodal points are aligned along a vertical line.

5. The camera system according to claim 1,
wherein each of the primary camera, the second camera, and the third camera is configured to capture a predefined region of an environment surrounding the camera system,
wherein the primary region captured by the primary camera is defined by a first radial boundary and a second radial boundary,
wherein a second predefined region captured by a second camera is defined by a third radial boundary and a fourth radial boundary, and
wherein the second radial boundary partially overlaps the third radial boundary.

6. The camera system according to claim 5, wherein the first radial boundary and the second radial boundary define an angle up to 185 degrees.

7. The camera system according to claim 6, wherein angle is 92 degrees.

8. The camera system according to claim 1, wherein the support structure comprises:
a base;
a beam extending upward from the base and having a first edge and a second edge, the first edge being perpendicular to the second edge,
wherein the primary camera is fastened to the first edge of the beam, and
wherein the second camera and the third camera are connected to the second edge of the beam.

9. The camera system according to claim 1, wherein the support structure comprises:
a base;
a first beam extending upward from the base and being connected to a first side edge of the second camera and a first side edge of the third camera; and
a second beam connected to a second side edge of the second camera and to a first side edge of a third camera,
wherein the primary camera is connected to the second beam.

10. The camera system according to claim 1, further comprising:
a fourth camera having a fourth lens defining a fourth optical axis extending in a third direction; and
a fifth camera having at fifth lens defining a fifth optical axis extending in the third direction such that the fifth optical axis is parallel to the fourth optical axis.

11. The camera system according to claim 10, further comprising:
a sixth camera having a sixth lens defining a sixth optical axis extending in a fourth direction; and
a seventh camera having at seventh lens defining a seventh optical axis extending in the fourth direction such that the seventh optical axis is parallel to the sixth optical axis.

12. A camera system for environment capture comprising:
a first camera defining a first optical axis extending in a first direction;
a second camera aligned with the first camera, the second camera defining a second optical axis extending in the first direction such that the first optical axis is parallel to the second optical axis;
a third camera defining a third optical axis extending in a second; and
a fourth camera defining a fourth optical axis extending in the second direction such that the third optical axis is parallel to the fourth optical axis.

13. The camera system according to claim 12, further comprising means for emulating a first virtual camera defining a first virtual optical axis extending in the first direction by combining first environment data captured by the first camera with second environment data captured by the second camera to form a first combined environment data, and for emulating a second virtual camera defining a second virtual optical axis extending in the second direction by combining third environment data captured by the third camera with fourth environment data captured by the fourth camera to form a second combined environment data, wherein the first virtual optical axis intersects the second virtual optical axis at a virtual nodal point.

14. The camera system according to claim 13, further comprising means for generating an environment map by stitching together the first combined environment data with the second combined environment data.

15. A method for generating an environment map comprising:
capturing first environment data using a primary camera having a first lens defining a first optical axis extending in a first direction, second environment data using a second camera having a second lens defining a second optical axis extending in a second direction; and third environment data using a third camera having at third lens defining a third optical axis extending in the second direction such that the third optical axis is parallel to the second optical axis;
combining the second and third environment data to emulate a virtual camera having a virtual nodal point located at the primary nodal point and a virtual optical axis extending in the second horizontal direction; and
stitching the primary environment data with the combined second and third environment data.

16. The method according to claim 15, further comprising
capturing fourth environment data using a fourth camera having a fourth lens defining a fourth optical axis extending in a third direction; and fifth environment data using a fifth camera having at fifth lens defining a fifth optical axis extending in the third direction such that the fifth optical axis is parallel to the fourth optical axis; and
combining the fourth and fifth environment data to emulate a second virtual camera having a second virtual nodal point located at the primary nodal point and a second virtual optical axis extending in the third direction,
wherein the step of stitching further comprises stitching the primary environment data with the combined second and third environment data and the combined fourth and fifth environment data.

17. The method according to claim 15, further comprising displaying the stitched environment data using an environment display system.
